(19) United States
(12) Patent Application Publication
(10) Pub. No.: US 2010/0064249 A1
(43) Pub. Date: Mar. 11, 2010

(54) Visual indicator in GUI system for notifying user of data storage device

(75) Inventor: Steven M. Groetken, Sioux City, IA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/231,734

(22) Filed: Sep. 5, 2008

(51) Int. Cl. G06F 3/14

(52) U.S. Cl. 715/781

(57) ABSTRACT

Data accessed by a processor to be displayed on the graphical user interface will have its data storage device visually coded. The visual code for the data storage device will be used on the window displaying the data on the graphical user interface. This visual coding will indicate to the user the location of the data for each window displayed on the graphical user interface.

### BACKGROUND

1. Field

The present invention relates to computer data storage devices, and more specifically to systems and methods to apply visually coded references to the graphical user interface (GUI) to help the user identify the source or storage location of the file or folder in use.

2. Description of Related Art

Nearly all computers are capable of running a large number of applications at one time from multiple data storage device locations. A typical user may have multiple programs open at once with data files for these programs in a number of unique locations. Open programs may include email, word processing, data analysis, accounting, maps, Internet, drawing, presentation and so forth. The data files for these programs may reside on one or more data storage device locations, for example, in the computer's primary data storage device, a secondary data storage device, a shared network data storage device, an external data storage device, flash data storage devices, mobile based devices, and CDs to name a few.

Users frequently access files available to them from data storage devices other than their primary computer's data storage device. Mistakenly saving files on the incorrect data storage device may create problems ranging in severity from simple embarrassment to loss of revenue or exposure to nefarious uses. For example, an engineer may prepare a visual presentation for a new product. As the presentation is prepared, design files are accessed from the company's network data storage device, presentation files are accessed from the removable storage device used the night before at home, and financial information from a business plan stored on the desktop's primary data storage device are also accessed. The engineer working with the data from these various data storage devices, without realizing it, could mistakenly save the presentation file on the computer's main data storage device. The day of the presentation the engineer takes the removable storage device thinking it contains the latest version of the presentation. As the presentation is started, it quickly becomes obvious that the new version of the presentation is not on the removable storage device. The correct version of the presentation is still stored in the data storage device of the engineer's computer.

Accessing secure, confidential, or classified data from its respective data storage devices and then saving to the incorrect data storage device is another challenge presented by the number of data storage device locations that exist. Businesses often create unique shared data storage device locations for each client. Accidently placing competitor's data in the incorrect client folder creates unnecessary and often costly problems. Mistakenly placing classified data in unclassified data storage device locations may cause the loss of the user's job.

What is needed is an intuitive visual method for users to be able to identify the data storage device for each file or folder open on their desktop such as visually coding each open window.

### SUMMARY

Embodiments disclosed herein address the above stated needs by providing systems and methods for visually indicating the data storage device for each window by visually coding it. Upon accessing a file or folder the computer will visually code the window displaying the information on the graphical user interface according to the coded scheme of the accessible data storage devices.

In one implementation of the disclosure, a method of visually coding a computer window to indicate a source of data displayed in the window comprises accessing a data storage device to retrieve data, displaying said data in the window, and visually coding the window to indicate the data being displayed is associated with said data storage device.

In another implementation, a software product is disclosed that comprises a machine readable medium including a program of instructions for visually coding a computer window to indicate a source of data displayed in the window. The program of instructions, upon being executed on a computer, causes the computer to perform activities that comprise accessing a data storage device to retrieve data, displaying said data in the window, and visually coding the window to indicate the data being displayed is associated with said data storage device.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts an exemplary window showing the available data storage device possibilities;

FIG. 2A depicts exemplary information handling systems that may be used with various embodiments of the present invention

FIG. 2B depicts a block diagram of an exemplary information handling system;

FIG. 3 is an exemplary graphical user interface that is visually coded according to various embodiments of the invention;

FIG. 4 is an exemplary graphical user interface that is visually coded illustrating data storage device file location changes made to FIG. 3; and

FIG. 5 is a flowchart of a method for practicing aspects of the invention.

### DETAILED DESCRIPTION

In general, a displayed window may provide or present a visual representation of the data contained in one or more files that are located storage devices. For example, text data of a file on a storage device may be displayed in the window of a word processing program as a series of characters arranged in the format of a document. As another example, image data of a file on a storage device may be displayed in the window of a photo-editing program as an image of a photograph. A window is a visual depiction of a form of data within a frame displayed on a screen, and is generally controlled by an operating system or identified application program.

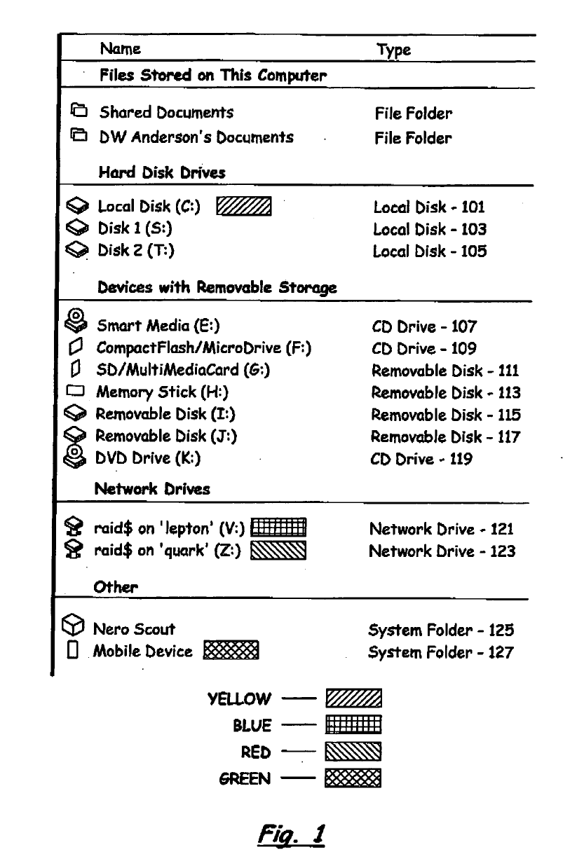

FIG. 1 depicts an exemplary window showing the available data storage device possibilities accessible by a particular computer for accessing data with the computer. In this embodiment the availability of data is shown by a window that the user can open. In other embodiments the availability of data sources may be indicated in other ways, for example, with a text listing of the sources, or represented by icons, or otherwise indicated in any like manner sufficient to convey the various sources of data available to the computer. Various embodiments of the present invention allow a document, media or other source of data to be matched to, associated with, or otherwise identified with, a storage source of the data, e.g., the data storage device from which the data was obtained by the program controlling display of the data. This may be done by having the window showing the data (or other visual representation of the data) visually coded in a manner that associates it with the storage source in which the data is stored. For example, in some embodiments this may be done by visually coding the listing of the data storage device in the window depicted in FIG. 1. By visually coding it is simply meant that some visual indicator of a predefined means such as color, line patterns, or any other visual means denotes the data storage device in a manner sufficiently unique to serve as an identifier for the data storage device. This may be done by providing a box around the listing of the data storage source of a particular color, line patterns, or other means. In other embodiments, instead of color coding the visual coding may be a predefined design (e.g., crosshatch pattern) or pattern of symbols, unique markings, or the like.

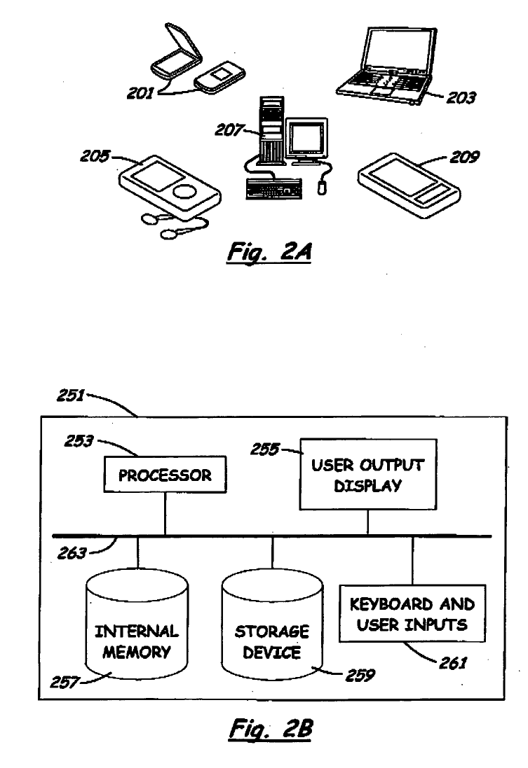

The exemplary computer window of FIG. 1 depicts a visual representation showing the data storage devices available to the computer. The term computer as used herein includes any information handling system able to access data storage devices and display the data in one or more windows. Examples of such devices can be found in FIG. 2A. The window shown in FIG. 1 exhibits fourteen possible data storage device locations accessible to the computer labeled 101-127. There are three local data storage devices 101-105 labeled “Hard Disk Drives”, seven Devices with Removable Storage 107-119, two network data storage devices 121-123 labeled “Network Drives”, and two “Other” miscellaneous data storage devices 125-127. Various embodiments of the present invention allow any subset of the available data storage devices to be visually coded to match data (e.g., a document being read) to its associated storage device where it is stored. For example, in some instances only one data storage device may be visually coded, while in other instance the system may be configured to visually encode some or all of the data storage devices to be visually coded.

The exemplary window of FIG. 1 illustrates visual coding for only the data storage devices in operation, that is, drives (C:), (Y:) and (Z:). The local data storage device (C:), 101, is color coded yellow. Since the drawings of this disclosure appear in black and white the color yellow is represented by a 45° single hatch pattern, as indicated in the legend shown on FIG. 1. In practice, on a computer screen the color yellow would be shown in any of several manners. For example, the words “Local Disk (C:)” could appear over a yellow background, or be surrounded by a yellow box, or may have yellow shadowing effects. The network data storage device (Y:), 121, is color coded blue, represented by a checkerboard pattern. The network data storage device (Z:), 123, is color coded red, represented by a single horizontal hatch pattern. The “Other” data storage device, Mobile Device, 127, is color coded green, represented by a cross hatch pattern. As mentioned above, in various implementations there may be more or fewer visually coded data storage devices than those shown in the window of FIG. 1. A legend similar to that depicted in FIG. 1 may be provided by the computer to allow the user to identify the source of data indicated by a given color or pattern. In some embodiments the legend may be provided in a drop down menu accessed by right clicking on the visual representation itself, or may alternatively be accessed within a computer program implementing the invention.

The data source visual coding associated with each window containing data remains intact with the windows as they are moved around, resized or otherwise manipulated by a user or by the computer itself. Typically, a windows based operating system allows windows appearing on the desktop or computer screen to be resized or moved through use of a mouse, touchpad, or other pointing mechanism. To resize a window the user clicks on an edge or corner of the window and drags it inward or outward to achieve a desired dimension for the window. Windows can be moved in a similar manner by clicking on the window (but not on an edge or corner) and dragging the entire window to a new location on the desktop. As windows are resized or moved the data source visual coding (e.g., identifying color coding or pattern) moves/resizes with the window, as part of the window.

FIG. 2A depicts some exemplary information handling systems that may be used to implement various embodiments of the present invention. The exemplary information handling systems shown in FIG. 2A include a desktop computer system 207, a notebook (or laptop) computer 203, a wireless device (e.g., a cellular telephone 201, a GPS system 209, or other wireless device) and a media content player 205 (e.g., a MP3 player or other device for storing or playing audio or video). These devices are included only as examples for illustrating aspects of the present invention. In practice, nearly any device that can access electronically stored information for retrieval and display can be configured to implement one or more embodiments of the invention.

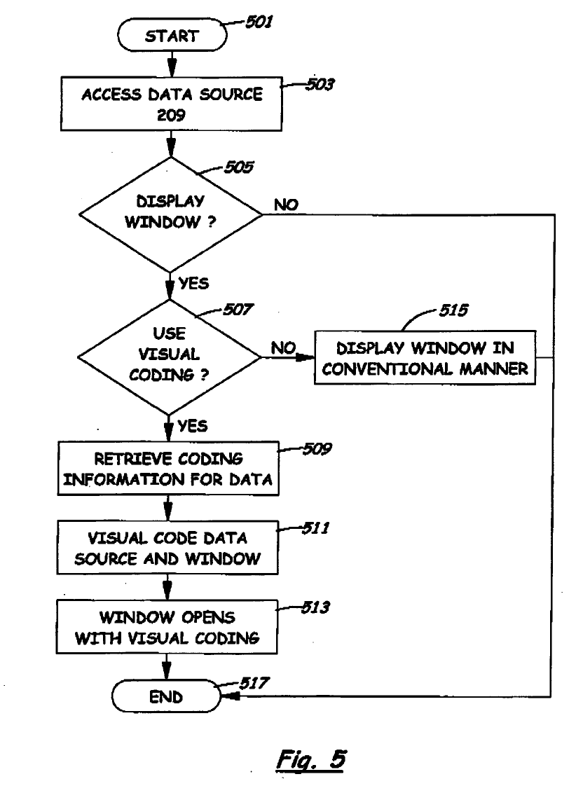

FIG. 2B depicts a block diagram 251 of an exemplary information handling system, and includes subsystems typical of an information handling system. The processor 253 may be embodied as a microprocessor, an application specific integrated circuit (ASIC), or any other circuitry or logic configured to perform or control the processes, steps and activities involved in practicing the embodiments disclosed herein, for example, the activities shown in FIG. 5. The processor 253 may be configured as a single unit or may be a combination of two or more distributed processors, or other circuitry or logic capable of carrying out commands or instructions. In various embodiments, the processor 253 may run a computer program, software, code, commands, routines or any other instructions which perform one or more of the activities depicted in FIG. 5, or otherwise discussed herein or known to those of ordinary skill in the art.

The processor 253 is interconnected to internal memory 257 and storage device 259. The components of the information handling system 251 are typically interconnected via one or more buses, represented in FIG. 2B as bus 263. For example, the processor 253 is configured to communicate with internal memory 257 and storage device 259 via the bus 263 or by way of another like type of wired or wireless communication links. Although the bus 263 is depicted as a single bus connecting all of the component parts of the system, the information handling system 251 may include two or more separate buses each connected to a subset of the system components.

The internal memory 257, sometimes referred to as a local memory, may be any of several types of internal storages used to store computer programs or code, including the instructions and data for carrying out activities of the various embodiments disclosed herein. The storage device 259 may be a hard disk drive of a computer system. Alternatively, the storage device 259 may be any sort of device that stores content, data or computer software of the information handling system 251 and is capable of being overwritten. The internal memory 257 and storage device 259 may be implemented in any form suitable for storing data in a computer system, for example, as random access memory (RAM), read only memory (ROM), flash memory, registers, hard disk, or removable media such as a magnetic or optical disk, or other storage medium known in the art. Either of the memories 257 and the devices 259 may include a combination of one or more of these or other such data storage technologies known to those of ordinary skill in the art. The internal memory 257 and storage device 259 may each be configured to store all or parts of a computer program product which performs the various activities to control and display windows and computer data in accordance with the various embodiments.

The information handling system 251 also includes one or more input/output (I/O) units such as user display output 255 and user input devices 261. The user output display 255 may take the form of a computer monitor or screen, or any other visual output device, including, for example, a liquid crystal display (LCD) screen, a cathode ray tube (CRT) monitor, or other like type of display screen or monitor. Typically, the output 253 is configured to display a view controlled by the processor 253 running the application software of the information handling system 251. The user output 255 may include other output devices, in addition to or in place of, a display monitor, such as one or more LED indicator lights, or audio speakers, or other like type of output units. The user input devices 261 may include one or more of a keyboard, a mouse, a tablet surface and pen, a microphone and speech recognition routine, or other like types of input/output devices known to those of ordinary skill in the art. The user input devices 261 may be interfaced to bus 263 by an I/O interface (not shown) and may be connected either by cables or wirelessly to the information handling system 263. The user output 255 and user input devices 261 may include other devices known to those of ordinary skill in the art and suitable for use communicating data and commands between the information handling system 251 and a user of the device.

The information handling system 251 may be connected to the Internet and/or one or more networks such as a local area network (LAN), a wide area network (WAN), the Public Switched Telephone System (PSTN), a wireless telephone network, or the like. The information handling system 251 may be connected via such networks to another information handling system, computer, dumb terminal, or communications device configured to implement the various activities disclosed herein.

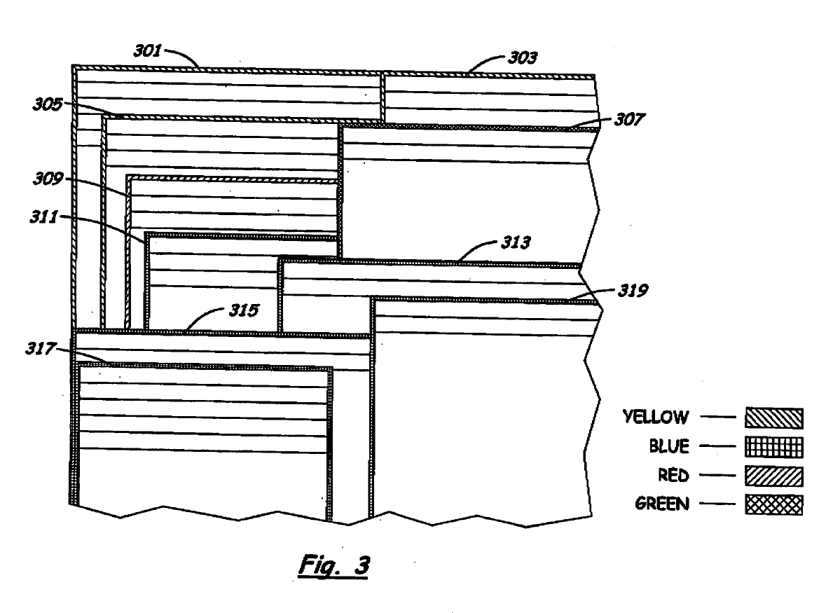

FIG. 3 is a depiction of graphical user interface (GUI) windows that are visually coded according to various embodiments of the invention. The window exemplifies a visually coded frame identifying the data source device described in FIG. 1. The three windows—Outlook 301, Internet Explorer 303, and file explorer 305—are from the local data storage device (C:) 101 visually indicated by the yellow color coded frame around each of them represented by the 45° single hatch pattern. The four windows—Microsoft Streets & Trips 311, Word 315, Publisher 313, Excel 317, and the Adobe Reader 319—are from the network data storage device (Y:) 121 visually indicated by the blue color coded frame around each of them represented by the checkerboard pattern. The Tenant Pro 309 red framed window represented by the horizontal line pattern indicates the data file is from network data storage device (Z:) 123. The Windows Mobile 307 green framed window represented by the cross hatch pattern indicates the data file is from the mobile data storage device 127.

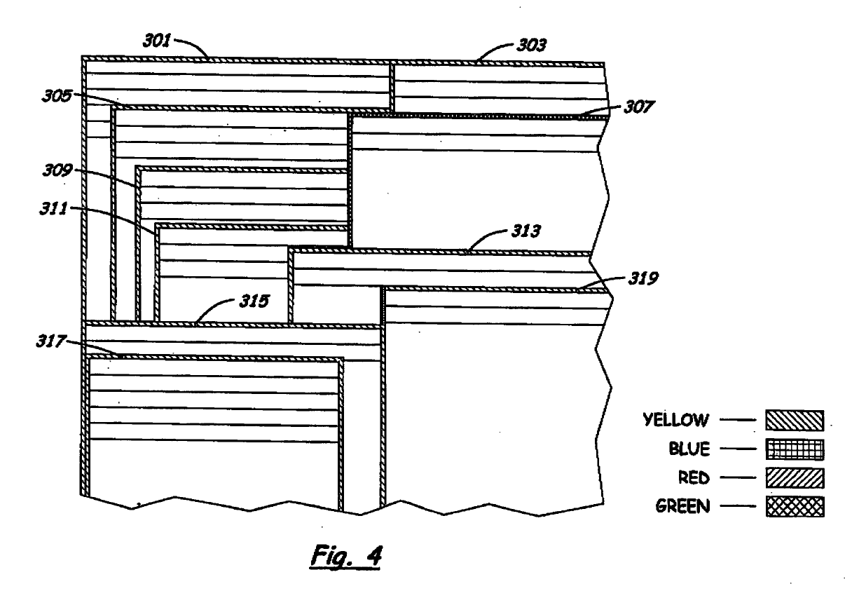

FIG. 4 is a visually coded graphical user interface showing user data storage device location changes made to FIG. 3. This exemplary drawing serves to demonstrate various embodiments of the invention. The user has moved all data to the computer's local data storage device location 101. Except for the Windows Mobile data 307 color coded green, represented by a cross hatch pattern, which resides on the data storage device location 127. This change is visually indicated by the color coding of all windows from the local data storage device location 101, Outlook 301, Internet Explorer 303, file explorer 305, Microsoft Streets & Trips 311, Word 315, Excel 317, Publisher 313, Adobe Reader 319 and Tenant Pro 309 with a yellow frame around each of them represented by a 45° single hatch pattern.

FIG. 5 is a flowchart of a method for practicing aspects of the invention. The method begins at 501 and proceeds to 503 to begin performing the visual coding of windows and the data storage device locations by accessing a data source. The activities causing the computer to access data from a storage device 259 are often the effect of a user's request or other action by the user such as opening a file. There may sometimes be instances of a request that causes the processor 253 to access various data storage devices 259 without a user request (e.g., a slide show may be set to randomly display images stored on the computer, thus changing the data source visual coding (color) as slides are pulled from different data sources). Once the request to access data has been made in 503 the method proceeds to 505.

In 505 it is determined whether the data accessed results in displaying a window on a GUI window of the display 255. If no window is to be displayed with the data, then the method may simply proceed to 517 along the “NO” branch and end in response to determining that the data does not need to be displayed. Back in block 505 if the processor determines that the data accessed from the data storage device 259 is to be displayed on display device 255 the method proceeds from 505 along the “YES” branch to 507.

In 507 it is determined whether or not visual encoding is to be used for the window displaying the data. If none of the various embodiments have been implemented on the computer then no visual encoding will be provided and the method proceeds along the “NO” path to 515 to display the data window in a conventional manner. In some instances the invention may be implemented but the user prefers to only use visual encoding with certain types of data files, e.g., only with MS Word documents. In such an instance if the data file retrieved in 209 is not to be visually encoded the method proceeds along the “NO” path to 515. If it is determined in 507 that the window is to be visually encoded the method proceeds along the “YES” path from 507 to 509. In block 509 the information for use in visually encoding the window is retrieved. Such information includes the type of encoding such as the specifics about the color or pattern to be used in encoding the window. The information also includes the listing of the colors/patterns to be used for each different source of data. The listing may specify the particular color/pattern to be used with a given data source such as hard drive c:\ and hard drive d:\. The listing may also specify the particular color/pattern, or a general scheme (e.g., shade of blue) to be used with a type of data source likely to be encountered such as a USB dongle memory the computer has not encountered before or is otherwise unidentified. Once the information needed to visually encode the data window has been retrieved in 509 the method proceeds to 511.

In 511 a visual indicator is assigned or otherwise associated with the data storage device 259. Various embodiments of the present invention allow for the visual indicator to be assigned by the processor 253 operating under control of computer instructions or software. The visual indicator may, in some instances, be assigned by the user, by industry standards, by convention, or in other like manners. For example, the user may prefer colors instead of line pattern indicators, and may want to assign a favorite color (or a bright, easily identifiable color) to the most commonly used data source. In another instance, the user may pick a color coding scheme with blue shades of color only, for aesthetic purposes. Perhaps, at some point, the industry may determine that for ease of use all visual indicators are to conform to a standardized set of line patterns. Or perhaps industry decides to assign key colors to the same data storage device in order to provide consistency to users moving from multiple machines. In this case, industry may assign all local data storage devices shades of red, network storage devices shades of green and so forth. The data storage device location will be visually coded in this step such as the devices found in the exemplary drawing in FIG. 1. Once the visual coding has been assigned to the data storage device 209, the method continues to 513.

In 513 the data is displayed in a window (e.g., a GUI window on the display device 255) using the visual coding determined in 511. As discussed above, this visual coding may be done with methods other than the line pattern coded frames found in the exemplary drawings FIGS. 3 and 4. Upon completing 513 the method proceeds to 517 and ends.

Various activities may be included or excluded as described above, or performed in a different order, with the rest of the activities still remaining within the scope of at least one exemplary embodiment. For example, the line pattern frames may only be on one side of the open window instead or all the way around the window. Maybe only the title bar of the window will be visually coded. Further, the windows displayed according to the present invention may comprise windows opened within another window, such as windows displaying data from different files that are opened within the window of an application program. For example, this may include windows displaying the data of individual photos from different sources within the window of a photo-editing program. Other variations to the embodiments are within the scope of this disclosure, as would be known by those of ordinary skill in the art.

The invention may be implemented with any sort of graphical user interface capable of performing the above stated functions and activities. The invention may be used to visually code any current and future storage device comprising of those shown in FIG. 1.

The invention may be implemented with any sort of processing units, processors and controllers (e.g., similar to processor 253 of FIG. 2B) capable of performing the stated functions and activities. A processing unit in accordance with at least one exemplary embodiment can operate computer software programs stored (embodied) on computer-readable medium such as a hard disk, CD, flash memory, RAM, firmware, or other computer readable medium as recognized by one of ordinary skill in the art. The visual coding procedure for performing the steps and activities described above can be a part of any current and future storage device comprising of those shown in FIG. 1.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A method of visually coding a computer window to indicate a source of data displayed in the window, the method comprising:
accessing a data storage device to retrieve data;
displaying a visual representation of said data in the window; and
visually coding the window to indicate that the visual representation of the data being displayed is associated with said data storage device.

2. The method of claim 1, wherein the data is first data, the data storage device is a first data storage device and the window is a first window visually coded with a first coding scheme, the method further comprising:
accessing a second data storage device to retrieve second data;
displaying a visual representation of said second data in a second window; and
visually coding the second window to indicate that the visual representation of the second data being displayed is associated with a second data storage device.

3. The method of claim 1, wherein the window is visually coded using a color coding scheme.

4. The method of claim 3, wherein the color coding scheme comprises coloring at least a portion of a border surrounding the window with a unique color not associated with any other data storage device.

5. The method of claim 1, wherein the window is visually coded using a pattern coding scheme.

6. The method of claim 5, wherein the pattern coding scheme comprises using a unique pattern on at least a portion of a border surrounding the window, the unique pattern not being associated with any other data storage device.

7. The method of claim 2, wherein the first data storage device is a predefined hard drive; and
wherein the second data storage device is a type of storage device.

8. The method of claim 1, wherein the type of storage device is a USB storage device.

9. The method of claim 1, further comprising:
detecting the accessing of the data storage device to retrieve data; and
retrieving information in response to the detecting of the accessing of the data storage device, said information specifying details for visually coding the window.

10. The method of claim 9, wherein said information specifies a unique color associated with the data storage device for visually coding the window.

11. A software product comprising a machine readable medium including a program of instructions for visually coding a computer window to indicate a source of data displayed in the window, wherein the program of instructions upon being executed on a computer causes the computer to perform activities comprising:
accessing a data storage device to retrieve data;
displaying a visual representation of said data in the window; and
visually coding the window to indicate that the visual representation of the data being displayed is associated with said data storage device.

12. The software product of claim 11, wherein the data is first data, the data storage device is a first data storage device and the window is a first window visually coded with a first coding scheme, the method further comprising:
accessing a second data storage device to retrieve second data;
displaying a visual representation of said second data in a second window; and
visually coding the second window to indicate that the visual representation of the second data being displayed is associated with a second data storage device.

13. The software product of claim 11, wherein the window is visually coded using a color coding scheme.

14. The software product of claim 13, wherein the color coding scheme comprises coloring at least a portion of a border surrounding the window with a unique color not associated with any other data storage device.

15. The software product of claim 11, wherein the window is visually coded using a pattern coding scheme.

16. The software product of claim 15, wherein the pattern coding scheme comprises using a unique pattern on at least a portion of a border surrounding the window, the unique pattern not being associated with any other data storage device.

17. The software product of claim 12, wherein the first data storage device is a predefined hard drive; and
wherein the second data storage device is a type of storage device.

18. The software product of claim 11, wherein the type of storage device is a USB storage device.

19. The software product of claim 11, further comprising:
detecting the accessing of the data storage device to retrieve data; and
retrieving information in response to the detecting of the accessing of the data storage device, said information specifying details for visually coding the window.

20. The software product of claim 19, wherein said information specifies a unique color associated with the data storage device for visually coding the window.
